(19) United States
(12) Patent Application Publication
(10) Pub. No.: US 2015/0165731 A1
(43) Pub. Date: Jun. 18, 2015

(54) COMPOSITE STRUCTURE WITH REINFORCED THERMOPLASTIC ADHESIVE LAMINATE AND METHOD OF MANUFACTURE

(71) Applicant: Gordon Holdings, Inc., Englewood, CO (US)

(72) Inventors: Edward D. Pilpel, Avon, CT (US); Benjamin D. Pilpel, Lone Tree, CO (US); Jonathan Spiegel, Aurora, CO (US)

(73) Assignee: Gordon Holdings, Inc., Englewood, CO (US)

(21) Appl. No.: 14/539,428

(22) Filed: Nov. 12, 2014

Related U.S. Application Data
(60) Provisional application No. 61/903,704, filed on Nov. 13, 2013.

(51) Int. Cl. B32B 21/08; B29C 70/30; B32B 5/12; B32B 27/08; B32B 27/36; B32B 27/20; B29C 70/06; B29C 70/54

(52) U.S. Cl. CPC B32B 21/08; B29C 70/06; B29C 70/30; B29C 70/54; B32B 27/08; B32B 27/36; B32B 27/20; B32B 5/12; B29L 2009/00

(57) ABSTRACT

Disclosed is a composite structure including a laminate integrally bonded to a substrate. The laminate includes a composite ply having a plurality of fibers in a thermoplastic matrix.

### CROSS-REFERENCE TO RELATED APPLICATIONS

This application claims priority to U.S. Provisional Application Ser. No. 61/903,704 (attorney docket number 1718-0001) filed on Nov. 13, 2013, entitled, Composite Structure with Reinforced Thermoplastic Adhesive Laminate and Method of Manufacture, the contents of which are hereby incorporated by reference in its entirety.

### TECHNICAL FIELD

The present disclosure relates to a combination of adhesive and composite laminate structures and to methods of their manufacture.

### BACKGROUND

In the manufacture of composite laminates, thermosetting resins such as phenolics, polyesters and other reactive thermosets have been used as matrix materials to make plies of composite fiber-resin material. In this process, for instance, pre-impregnated items of manufacture for use in subsequent manufacturing steps incorporating plies of fibers or fabrics wet with reactive thermosetting resins in liquid form and stacked on top of one another are subjected to pressure and heat. The stacked material is typically subjected to a curing cycle where the heat-curable thermosetting resins are cured or set up to produce the final structure. Any material that must be trimmed is scrapped because the thermosetting resins cannot be recycled back into the production process.

Additionally, handling reactive (i.e., curable) liquids can be problematic due to the possibility of, e.g., spills, contamination and operator contact. The thermosetting resins and dust therefrom may also present exposure hazards to workers, and disposal of the reactive thermosetting material could also be difficult. Thermoset materials are also often hard and brittle, and thus can have limited high strength applications and uses. Also, the bonding of a thermoset composite requires the introduction of an adhesive bond layer to join the thermoset composite to an adjoining substrate, such as wood, ceramic, metal, plastic and, in general, to most materials.

Accordingly, what is needed is an alternative composite structure that incorporates an adhesive property within the thermoplastic matrix and is, e.g., economical, can withstand high loads, resist weather damage and damage from operator interaction, and can have an increased usable lifespan in comparison to thermoset composites or even non-composite structures. There is also a need for such alternative composite structures having varied applications, such as in building panels, flooring for buildings, homes, trailers or other structures, as well as further applications such as in roofs, ceilings, doors and armor panels, among other applications. Embodiments disclosed herein address the above needs, as well as others.

### SUMMARY

According to aspects illustrated herein, there is provided a composite structure. The composite structure comprises: a laminate comprising a composite ply, wherein the composite ply comprises a plurality of fibers in a thermoplastic matrix; and a substrate. The laminate is integrally bonded to the substrate.

According to further aspects illustrated herein, there is provided an apparatus for making the afore-referenced composite structure. The apparatus comprises a preheat section configured to receive and heat the laminate and the substrate creating an integral bond between the laminate and the substrate to form a preheated laminate/substrate layup; an unwind section configured to deliver the laminate to the preheat section; and a double belted laminating press for receiving the preheated laminate/substrate layup. The double belted laminating press comprises a first belt and a second belt configured to pull the preheated laminate/substrate layup into the double belted laminating press; and a heating section configured to receive and further heat the laminate/substrate layup to produce a heated composite structure. The double belted laminating press further comprises pressure rollers configured to receive the heated composite structure; and a cooling section configured to receive the heated composite from the pressure rollers and remove heat from the structure.

According to further aspects, there is provided a method for making the afore-referenced composite structure. The method comprises preheating the laminate and substrate creating an integral bond between the laminate and the substrate to form a preheated laminate/substrate layup; and providing a double belted laminating press for receiving the preheated laminate/substrate layup; wherein a first belt and a second belt of the laminating press pull the preheated laminate/substrate layup into the double belted laminating press for processing. The method also comprises further heating in a heating section of the laminating press the preheated laminate/substrate layup to produce a heated composite structure; pressing the heated composite structure with the use of pressure rollers in the laminating press; and cooling the heated composite structure in a cooling section of the laminating press after the heated composite structure exits the pressure rolls.

According to another aspect, there is provided an apparatus for making an integrally bonded composite structure, the composite structure comprising a) a laminate comprising a composite ply, the composite ply comprising a plurality of fibers in a thermoplastic matrix; and b) a substrate, wherein the laminate is integrally bonded to the substrate. The apparatus comprises: a heating section configured to receive and heat the laminate and the substrate to form a heated laminate/substrate layup; and an unwind section configured to deliver the laminate to the heating section. The apparatus further comprises a set of rolls configured to receive the heated laminate/substrate layup from the heating section to press the laminate into the substrate forming a bonding interface in the composite structure; a pressure bonding section configured to receive the composite structure from the set of rolls; and a cooling section configured to cool and solidify the bonding interface.

According to a further aspect, there is provided an apparatus for making an integrally bonded composite structure, the composite structure comprising a) a laminate comprising a composite ply, the composite ply comprising a plurality of fibers in a thermoplastic matrix; and b) a substrate, wherein the laminate is integrally bonded to the substrate. The apparatus comprises a heating section configured to receive and heat the laminate and the substrate to form a heated laminate/substrate layup; an unwind section configured to deliver the laminate to the heating section; and a first set of rolls configured to receive the heated laminate/substrate layup from the heating section to press the laminate into the substrate forming a bonding interface in the composite structure. The apparatus also comprises a pressure bonding section configured to receive the composite structure from the first set of rolls; a second set of rolls configured to receive the composite structure from the pressure bonding section and further press the composite structure; and a first cooling section configured to receive the composite structure from the second set of rolls to solidify the bonding interface and form a bond therebetween. The apparatus further comprises a third set of rolls configured to receive the composite structure from the cooling section and further press the composite structure to maintain the bond; a second cooling section configured to receive the composite structure from the third set of rolls to remove heat from the composite structure; and a fourth set of rolls configured to receive the composite structure from the second cooling section and further press the composite structure, thereby forming the integrally bonded composite structure.

According to a further aspect, there is provided a method of making an integrally bonded composite structure, the composite structure comprising a laminate comprising a composite ply, wherein the composite ply comprises a plurality of fibers in a thermoplastic matrix; and a substrate, and the laminate is integrally bonded to the substrate. The method comprises a) heating the laminate and the substrate to form a heated laminate/substrate layup; b) pressing the laminate of the heated laminate/substrate layup into the substrate of the heated laminate/substrate layup using at least one set of calendaring nip rolls to form a bonding interface in the composite structure; and c) applying high pressure of at least about 100 psi to the composite structure of b). The method further comprises d) cooling and solidifying the bonding interface of the composite structure of c).

### BRIEF DESCRIPTION OF THE DRAWINGS

FIG. 1 is an expanded, schematic perspective view of a composite structure comprising a three layer/ply laminate and a substrate, according to embodiments;

FIG. 2 is an expanded, schematic perspective view of a composite structure comprising a five layer/ply laminate and a substrate, according to embodiments;

FIG. 3 is a schematic perspective view of a composite structure comprising a five layer/ply laminate bonded to a substrate, according to embodiments;

FIG. 4 is a schematic view of a double belted apparatus, which can be employed in the manufacture of a composite structure, according to embodiments; and

FIG. 5 is a schematic view of another apparatus, which can be employed in the manufacture of a composite structure, according to embodiments.

### DETAILED DESCRIPTION

In contrast to the afore-described problems associated with thermoset matrix composites and according to embodiments of the invention, composite structures employing a reinforced thermoplastic matrix are easier, cleaner and simpler to handle and produce. Any waste material can be reworked into the process because the thermoplastic resins typically do not cure or crosslink during processing, molding or heating. No special storage is required and shelf life of a thermoplastic based material is virtually indefinite, making in-process inventory usable without regard to when they were manufactured. Moreover, the mechanical properties of a thermoplastic vary greatly as compared with a thermoset material. For example, thermoset materials are often hard and brittle while thermoplastics can be more pliable and subject to easier post-processing.

Thus, embodiments of the invention overcome problems associated with thermoset materials and result in high strength, multi-applicational structures. The adhesive attribute of the thermoplastic matrix is typically activated with heat to soften and flow the composite matrix where it is placed under pressure and cooled to complete the bonding process to an adjoining substrate. Also, according to embodiments, the use of an amorphous thermoplastic matrix has the added advantage of having full properties immediately after processing, e.g., meaning no additional normalization as is typical with some crystalline thermoplastics.

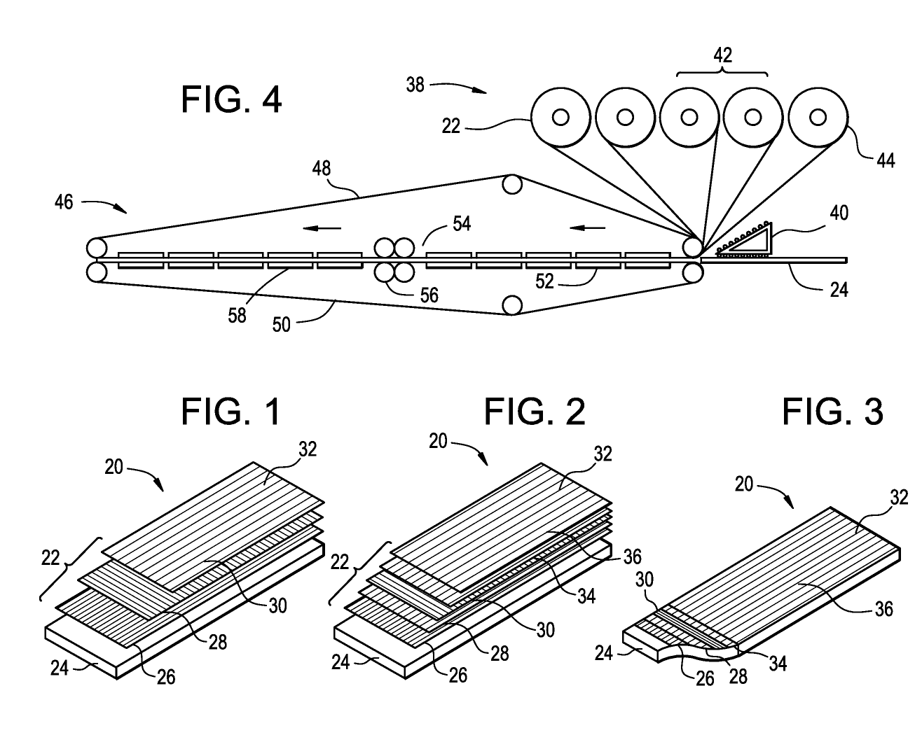

Accordingly, with reference to FIG. 1, disclosed therein is a composite structure 20 comprising a laminate 22 and a substrate 24. In the non-limiting embodiment of FIG. 1, the laminate 22 is shown as comprising a plurality of composite plies (layers), specifically a first composite ply 26, a second composite ply 28 and a third composite ply 30 for bonding to substrate 24. However, it will be appreciated that laminate 22 could comprise more or less composite plies. For example, laminate 22 could be a uni (one) composite ply, which is then bonded to substrate 24. Similarly, laminate 22 could be a five composite ply, as described, e.g., in further detail below with respect to FIGS. 2 and 3.

According to embodiments and as shown in, e.g., FIG. 1, each ply comprises a plurality of reinforcing fibers 32 that are typically longitudinally oriented (that is, they are aligned with each other), and typically continuous across the ply. The composite plies of the laminate 22 may include fibers 32 that are continuous, chopped, random comingled and/or woven. In particular embodiments, composite plies as described herein may contain longitudinally oriented fibers to the substantial exclusion of non-longitudinally oriented fibers.

The plurality of reinforcing fibers 32 is impregnated with a thermoplastic matrix material to form, e.g., a wetted, very low void composite ply, typically to the substantial exclusion of thermosetting matrix material. The reinforcing fibers 32 can be encapsulated in the thermoplastic matrix material.

Regarding the types of reinforcing fibers 32 to be employed in the thermoplastic matrix material, it will be appreciated that any suitable fibers 32, and in any desirable amounts, may be employed in one or more composite plies of the laminate 22 depending upon, e.g., desired applications, strengths and so forth. Non-limiting examples of reinforcing fibers 32 include glass fibers in general (e.g., fiberglass), E-glass fibers, S-glass fibers, and so forth. E-glass is a low alkali boro silicate glass with good electrical and mechanical properties and good chemical resistance. Its high resistivity makes E-glass suitable for electrical composite laminates. The designation “E” is for electrical.

S-glass is the higher strength and higher cost material relative to E-glass. S-glass is a magnesia-alumina-silicate glass employed in, e.g., aerospace applications with high tensile strength. Originally, “S” stood for high strength.

E-glass fiber may be incorporated in a composite ply in a wide range of fiber weights and thermoplastic matrix material. As non-limiting examples, the E-glass may range from about 10 to about 40 ounces per square yard (oz./sq.yd.), from about 19 to about 30, and from about 21 to about 29 oz./sq.yd. of reinforcement, and all values therebetween the foregoing ranges.

The quantity of S-glass or E-glass fiber in a composite ply could, for example, comprise about 40 to about 90 weight percent (wt %) thermoplastic matrix, about 50 to about 85 wt %, and about 60 to about 80 wt % thermoplastic matrix in the ply, based on the combined weight of thermoplastic matrix plus fibers 32, as well as all values therebetween the foregoing ranges.

As further non-limiting examples, according to embodiments, a composite ply of laminate 22 may comprise about 5 wt. % to about 80 wt. % thermoplastic matrix, about 10 wt. % to about 60 wt. % thermoplastic matrix, and about 20 wt. % to about 60 wt. % thermoplastic matrix, by weight of thermoplastic matrix material plus fibers 32, also including all values therebetween the foregoing ranges.

Any desired combination of fibers 32 may be employed in a composite ply and the fibers 32 may be the same or different. It is noted that the term “different fibers” can refer to different materials and/or different grades of the same material. As a non-limiting example, different fibers may be incorporated in combination with E-glass and/or S-glass and/or other glass fibers, and optionally instead of such fibers. Examples of other fibers include ECR, A and C glass, as well as other glass fibers; fibers formed from quartz, magnesia aluminosilicate, non-alkaline aluminoborosilicate, soda borosilicate, soda silicate, soda lime-aluminosilicate, lead silicate, non-alkaline lead boroalumina, non-alkaline barium boroalumina, non-alkaline zinc boroalumina, non-alkaline iron aluminosilicate, cadmium borate, alumina fibers, asbestos, boron, silicone carbide, graphite and carbon such as those derived from the carbonization of polyethylene, polyvinylalcohol, saran, aramid, polyamide, polybenzimidazole, polyoxadiazole, polyphenylene, PPR, petroleum and coal pitches (isotropic), mesophase pitch, cellulose and polyacrylonitrile, ceramic fibers, metal fibers as for example steel, aluminum metal alloys, and so forth.

Further examples include organic polymer fibers formed from an aramid exemplified by Kevlar and other high performance fibers. Other high performance, unidirectionally-oriented fiber bundles generally have a tensile strength greater than 7 grams per denier. These bundled high-performance fibers may be any one of, or a combination of, aramid, extended chain ultra-high molecular weight polyethylene (UHMWPE), poly [p-phenylene-2,6-benzobisoxazole] (PBO), and poly[diimidazo pyridinylene (dihydroxy) phenylene]. The use of these very high tensile strength materials is particularly useful for high strength composite panels including composite ballistic armor panels and similar applications requiring very high ballistic properties.

Still other fiber types known to those skilled in the particular art can be employed. For example, Aramid fibers such as, inter alia, those marketed under the trade names Twaron, and Technora; basalt, carbon fibers such as those marketed under the trade names Toray, Fortafil and Zoltek; Liquid Crystal Polymer (LCP), such as, but not limited to LCP marketed under the trade name Vectran. Embodiments of the invention contemplate the use of organic, inorganic and metallic fibers either alone or in combination.

The thermoplastic matrix material comprising the reinforcing fibers 32 of a composite ply of laminate 22 is any suitable thermoplastic matrix material. For example, the matrix material may comprise a polymer that is a high molecular weight thermoplastic polymer, including but not limited to, polypropylene, polyethylene, nylon, PEI (polyetherimide), PET (polyethyleneterephthalate), PA (polyamide), ABS (acrylonitrile butadiene styrene) and copolymers/combinations thereof.

Thermoplastic loading by weight can vary widely depending on physical property requirements of the finished part and the nature of the manufacturing method being utilized, and various methods are known in the art by which the reinforcing fibers 32 in a ply may be impregnated with, and optionally encapsulate by, the thermoplastic matrix material. Such non-limiting examples include a doctor blade process, lamination, pultrusion, extrusion, and so forth. It is further noted that a composite ply described herein can be produced in a continuous process and stored in rolls.

As noted above, composite structure 20, according to embodiments can comprise one or more composite plies, as described herein. If more than one composite ply is employed, as shown in, e.g., FIGS. 1, 2 and 3, the plies can be layered or bound together in any desired/suitable orientation. For example, laminate 22 of composite structure 20 could comprise two composite plies that are bound together with their respective fibers 32 in transverse relation to each other. Since fibers 32 within a composite ply are longitudinally oriented, according to embodiments, a composite ply in laminate 22 can be disposed with the fibers 32 in a specified relation to the fibers in one or more other composite plies.

In the embodiment illustrated in FIG. 1, laminate 22 comprises the first composite ply 26 as a 0° (degree) unidirectional reinforced thermoplastic composite ply with respect to itself as a reference direction and for bonding with substrate 24. Positioned on the first composite ply 26 is the second composite ply 28 as a 90° unidirectional reinforced thermoplastic composite ply with respect to ply 26 and for bonding therewith. As further shown in FIG. 1, positioned on the second composite ply 28 is the third composite ply 30 as a 0° unidirectional reinforced composite ply and for bonding with ply 28. However, it will be appreciated that other number of plies and/or other orientations of the plies could be employed, according to embodiments.

FIG. 2 illustrates an embodiment of composite structure 20 comprising laminate 22 having five composite plies. Specifically, in the embodiment shown in FIG. 2, laminate 22 comprises the first composite ply 26 as a 0° (degree) unidirectional reinforced thermoplastic composite ply with respect to itself as a reference direction and for bonding with substrate 24. Positioned on the first composite ply 26 is the second composite ply 28 also as a 0° unidirectional reinforced thermoplastic composite ply with respect to ply 26 and for bonding therewith. As further shown in FIG. 2, positioned on the second composite ply 28 is the third composite ply 30 as a 90° unidirectional reinforced composite ply and for bonding with ply 28. Positioned on the third composite ply 30 is a fourth composite ply 34 as a 0° unidirectional reinforced composite ply and for bonding with ply 30. Lastly, as shown in FIG. 2, positioned on the fourth composite ply 34 is a fifth composite ply 36 as a 0° unidirectional reinforced composite ply for bonding with ply 34.

As noted above, each ply of laminate 22 can comprise fibers 32 that are the same or different than the fibers 32 of other plies, and in any combination/ply orientation. For example, fibers 32 in a composite ply can be disposed in transverse relation to different fibers 32 or the same fibers 32 in an adjacent composite ply, e.g., at 90° to the fibers in the adjacent composite ply, according to embodiments. Composite plies may be referred to herein as being in transverse relation to each other (optionally at 90° to each other) without specific mention of the fibers 32 in each of the plies, and it will be appreciated that angles other than 90° may be employed. Other angles may be chosen for desired properties with less than or more than 90° for an adjacent composite ply. For example, in a non-limiting configuration wherein a first composite ply is deemed to define a reference direction (i.e., 0°), a second composite ply could be disposed at a first angle (for example, a positive acute angle) relative to the first composite ply (for example, about 45°) and a third composite ply could then be disposed at a second angle different from the first angle (for example, a negative acute angle) relative to the first ply (that is, at an acute angle in an opposite angular direction from the second ply (for example, about −45°). Thus, the plies may or may not be perpendicular to each other. For example, laminate 22 may contain a composite ply disposed in parallel to an adjacent composite ply, particularly an adjacent ply that comprises the same kind of or different fibers.

Similarly, the matrix material can vary from ply-to-ply and can be in the form of different thermoplastics. Alternatively, the matrix material can be the same from ply-to-ply. Any desired combinations of thermoplastic matrix materials, number of plies, fibers and orientations thereof are contemplated, according to embodiments. Similarly, any desirable, thicknesses of the plies could be employed depending upon, e.g., the resultant application of the structure.

As described in further detail below, the laminate 22 comprising the one or more composite plies is bonded to substrate 24. The substrate 24 comprises any suitable substrate and in any desired thickness, strength, and so forth, depending upon, e.g., the use and application of the resultant composite structure 20. For example, substrate 24 can include, but is not limited to, wood including oak wood, plywood, OSB (oriented strand board), MDF (medium density fiber board) and engineered wood in general; stone; ceramic; tile; metal; thermoplastic foam, polymeric material in general; and combinations of the foregoing. Moreover, it is noted that substrate 24 could comprise one or more layers of substrate material, in any combination of materials.

In a particularly suitable embodiment, the thermoplastic matrix of at least one composite ply comprises PET, the reinforcing fibers 32 comprise glass fibers (e.g., fiberglass), and the substrate 24 comprises wood, particularly oak, maple wood and/or other wood species that are used in structural applications. Also according to particularly suitable embodiments such as the foregoing, the laminate 22 is typically pliable (bendable) and the substrate 24 provides desirable bend resistance properties to the resultant composite structure 20.

The laminate 22 can be formed by, e.g., stacking individual composite plies one-on-the-next in any desired orientation with respect to each other. Thus, various methods can be employed to bond composite plies together to form laminate 22, including stacking the composite plies one on the next and applying heat and/or pressure, or using adhesives in the form of liquids, hot melts, reactive hot melts or films, epoxies, methylacrylates and urethanes. Sonic vibration welding and solvent bonding can also be employed.

The one or more afore-referenced plies of laminate 22 can be bonded to the substrate 24 using advantageous bonding techniques and multiple process variations. For example, FIG. 4 illustrates a suitable apparatus for bonding the laminate 22 to the substrate 24. Specifically, FIG. 4 depicts an example of an apparatus 38, which can be used to manufacture composite structure 20, according to embodiments. In general and as further described in more detail below, the apparatus 38 for making the composite structure 20 comprises a preheat section 40 configured to receive and heat both the laminate 22 and the substrate 24 forming a bond between the laminate 22 and the substrate 24. The apparatus 38 also comprises an unwind section 42 configured to deliver the laminate 22 to the preheat section 40; and a double belted laminating press 46 for receiving the preheated laminate 22/substrate 24 layup. The double belted laminating press 46 comprises a first belt 48 and a second belt 50 configured to pull the preheated laminate 22/substrate 24 layup into the double belted laminating press 46; and a heating section 52 configured to receive and further heat the materials to produce a heated composite structure 54. As further shown in FIG. 4, the double belted laminating press 46 of the apparatus 38 further comprises pressure rollers 56 configured to receive the heated composite structure 54; and a cooling section 58 configured to receive the heated composite structure 54 from the pressure rollers 56 and remove heat to produce a strengthened composite structure 20.

Referring now to the elements and functioning of the apparatus 38 in more detail, the apparatus 38 of FIG. 4 comprises preheat section 40, which is typically a preheat oven comprising infrared emitting bulbs. The preheat section 40 is configured to receive and heat both the substrate 24 and laminate 22, and typically comprises a series of infrared heaters to heat the bonding surfaces of the input materials (e.g., substrate 24 and laminate 22). It has been advantageously determined that if the substrate 24 and laminate 22 are not sufficiently preheated, the thermoplastic material (typically PET) of the laminate 22 will solidify before the laminate material has a chance to melt into the substrate 24 (typically wood). It will be appreciated that the preheating temperatures and times can vary depending upon the particular materials employed.

A bond is thereby created between the laminate 22 and substrate 24 as a result of such preheating and processing, which is typically a mechanical and integral bond between the materials, assisting in the resultant composite structure's 20 ability to possess, e.g., high load capabilities, excellent water permeability resistance and impact resistant properties.

Thus, as further shown in FIG. 4, the preheat section 40 receives the substrate 24 and the laminate 22 for the afore-described preheating of the materials. The exemplary apparatus 38 of FIG. 4 depicts an unwind station 42 comprising five rolls 44 of composite ply (e.g., reinforced thermoplastic matrix material) for a five ply laminate 22. However, it will be appreciated that more or less rolls 44 could be employed depending on the desired number of plies for the laminate 22. The unwind section 42 is configured to unwind the desired number of rolls 44 of plies for depositing onto the substrate 24 and preheating in the preheating section 40. Once the laminate 22 of desired number of ply(ies) and substrate 24 are preheated, as described above, the laminate 22 bonded to the substrate 24 then enters the double belted laminating press 46 where the materials are further heated in the heating section 52, pressed with a series of pressure rolls 56 and then cooled in cooling section 58.

More specifically and as shown in FIG. 4, after exiting the preheat section 40, the preheated laminate 22 bonded to the preheated substrate 24 enters the double belted laminating press 46 of the apparatus 38. The press 46 comprises a first (e.g., upper) belt 48 and a second (e.g., lower) belt 50 which pull the preheated laminate 22/substrate 24 layup into a heating section 52 of the double belted laminating press 46. The belts 48, 50 are typically made of steel. However, it will be appreciated that other material can be employed such as PTFE (polytetrafluoroethylene)/fiberglass belts, and so forth.

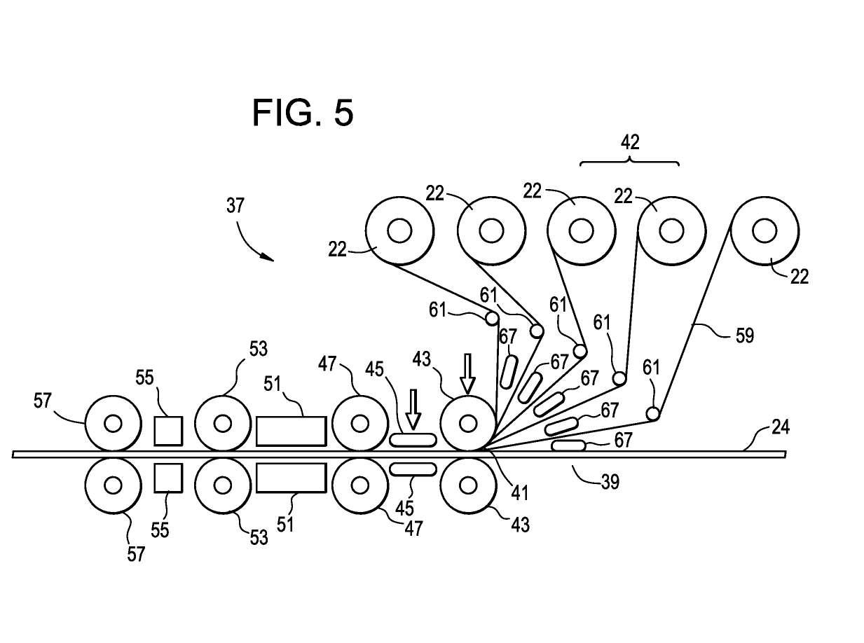

In the heating section 52, the preheated laminate 22/substrate 24 layup is further heated to between about 150° C. and about 300° C. for between about 3 seconds and about 120 seconds; typically between about 220° C. and about 250° C. for between about 5 seconds and about 10 seconds, including all values therebetween the foregoing ranges. It will be appreciated that the foregoing values are merely examples and such time and temperature parameters could vary depending upon, e.g., the particular materials employed. The heating section 52 typically comprises heated platens, such as electric and/or oil, however, other heating elements could be employed. Heated composite structure 54 is thereby produced, as shown in FIG. 4, which then passes through pressure rolls 56. The pressure rolls 56 can comprise one or more sets of opposing rollers, which apply pressure to the heated composite structure 54 comprising the laminate 22 and substrate 24. The additional heating in heating section 52 and pressurization by pressure rolls 56, e.g., can further cure and impregnate the reinforcing fibers 32 of the matrix of the laminate 22 and further enhance bonding and strengthening of the heated composite structure 54. As further shown in FIG. 4, heated composite structure 54 then passes through cooling section 58, which typically comprises water cooled platens, to remove heat and further strengthen the materials to produce, e.g., a strengthened, integrally bonded composite structure 20. It is further noted that the strengthened, integrally bonded composite structure 20 could also be produced by heating the afore-described laminate 22 and substrate 24, and pressing the materials together with use of a series of calendaring/nip rolls. Typically, the material is unwound and subjected to heating with the use of, e.g., infrared emitting bulbs as the material enters the nip rolls. Upon exiting the nip rolls, the pressed laminate 22/substrate 24 can be cooled with the use of water and cross air flow. For example, FIG. 5 illustrates such a suitable apparatus for bonding the laminate 22 to the substrate 24. Specifically, FIG. 5 depicts an example of an apparatus 37 comprising calendaring or nip rolls, which can be used to manufacture composite structure 20, according to embodiments.

In general and as further described in more detail below, the apparatus 37 for making an integrally bonded composite structure 20 comprises a heating section 39 configured to receive and heat the laminate 22 and the substrate 24 to form a heated laminate/substrate layup 41; an unwind section 42 configured to deliver the laminate 22 to the heating section 39; and a first set of rolls 43 configured to receive the heated laminate/substrate layup 41 from the heating section 39 and press the laminate 22 into the substrate 24 forming a composite structure having a bonding interface. The apparatus 37 also comprises a pressure bonding section 45 configured to receive the composite structure from the first set of rolls 43; a second set of rolls 47 configured to receive the composite structure from the pressure bonding section 45 and further press the composite structure; and a first cooling section 51 configured to receive the composite structure from the second set of rolls 47 to solidify the bonding interface and form a bond therebetween. The apparatus 37 further comprises a third set of rolls 53 configured to receive the composite structure from the first cooling section 51 and further press the composite structure to maintain the bond; a second cooling section 55 configured to receive the composite structure from the third set of rolls 53 to remove heat from the composite structure; and a fourth set of rolls 57 configured to receive the composite structure from the second cooling section 55 and further press the composite structure, thereby forming the integrally bonded composite structure 20. It is noted that while the non-limiting and exemplary apparatus 37 depicted in FIG. 5 is shown with, e.g., four sets of rolls, more or less rolls could be employed, according to embodiments. Similarly, while a first cooling section 51 and a second cooling section 55 are shown in FIG. 5, more or less cooling sections could be employed, according to embodiments. Still further, while five rolls of composite plies are shown in the unwind section 42, it will be appreciated that more or less could be employed, according to embodiments.

Referring now to the afore-referenced elements of apparatus 37 in more detail, the unwind section 42 is shown in FIG. 5 as comprising five tension controlled spindles 59, one for each of the five composite plies or layers of the CFRT (composite fiber reinforced thermoplastic) laminate 22. The unwind section 42 also comprises, according to embodiments, a material alignment, guiding and deflection system, which typically includes active pivot steering rollers 61. During processing, the CFRT laminate 22 is typically guided to align the edge of the laminate 22 to the incoming substrate 24, both of which are received by heating section 39.

The heating section 39 is shown in FIG. 5 as comprising five infrared quartz emitters 67. However, more or less emitters 67 could be employed depending upon, e.g., the number of the composite plies in the unwind station 42. Typically the emitters 67 include about 1000 to about 1200 watts per inch density with a range of about 500 to about 2000 watts per inch density, and are individually controlled with phase angle controllers to respond to material temperature feed back. However, it will be appreciated that other heating devices/elements could be employed in heating section 39.

Advantageously, with use of apparatus 37 and according to embodiments the entire substrate 24 including all surfaces thereof, e.g., an entire block of wood, does not need to be heated to effect the integral bonding described herein. Thus, significant cost savings can be achieved. In particular, according to embodiments it is sufficient to heat just the bonding surface of the laminate plies with emitters 67 and, typically, the bonding surface is heated up to about the melting temperature of the thermoplastic resin matrix of the laminate 22 to induce flow of the resin into the bonding interface between the substrate 24 and laminate 22. Thus, the heating temperature employed in heating section 39 is dependent upon the melt temperature of the thermoplastic resin, according to embodiments. Non-limiting examples of suitable temperature ranges include about 100° C. (212° F.) to about 300° C. (572° F.), about 100° C. (212° F.) to about 232° C. (450° F.), about 180° C. (356° F.) to about 220° C. (428° F.), typically about 200° C. (392° F.) to about 230° C. (446° F.). It is further noted that, according to embodiments, the surface of the substrate 24, e.g., wood surface, could also be similarly heated to reduce a freezing effect of the thermoplastic material upon contact with the substrate 24.

As shown in FIG. 5, a first set of rolls 43 receives the heated laminate/substrate layup 41 from the heating section 39 and presses the laminate 22 into the substrate 24 forming a composite structure having a bonding interface. It is noted that the temperature of the substrate 24 prior to entering the heating section 39 is typically between about 160° C. (320° F.) to about 350° C. (662° F.) and desirably about equal to the temperature of the laminate 22 (reinforced thermoplastic), such as between about 220° C. (428° F.) to about 300° C. (572° F.). During processing between the first set of rolls 43, the temperature of the laminate 22 (reinforced thermoplastic) is typically between about 160° C. (320° F.) to about 350° C. (662° F.) and desirably about equal to the temperature of the substrate, such as between about 220° C. (428° F.) to about 300° C. (572° F.), according to embodiments.

The first set of rolls 43 comprises adjustable height and pressure controls, and is typically about 1 to 3 inches in height operating at about 5 psi with a machine range of about 0 psi to about 200 psi. Similarly, the temperature and flow are adjustable, and exemplary parameters include about 10 to 15 gal/min at about 60 psi at a temperature of about 4° C. (40° F.) to about (121° C.) 250° F. including about (21° C.) 70° F. to about (38° C.) 100° F. Typically, the first set of rolls 43 comprises nip or calendaring rolls. The preferred temperature of the rolls 43 is about the same as the melting temperature of the CFRT laminate 22. The rolls 43 are typically constructed of a conforming material, such as silicone, to account for possible variations in the surface of the substrate 24. During processing, the rolls 43 press molten thermoplastic resin into the substrate 24, such as into the grains of wood, thereby initiating the bonding interface.

As the composite now comprising the heated CFRT laminate 22/substrate 24 layup 41 including the afore-described bonding interface advances past the first set of rolls 43, according to FIG. 5, the composite enters the pressure bonding section 45, typically comprising a smaller set of temperature controlled nip/calendar rolls that press and can cool the composite to further facilitate the bond between the materials. In the pressure bonding section 45, according to embodiments, the composite is subjected to high pressure, typically about 100 psi and at least about 10 psi, with a machine range of about 0 psi to about 200 psi. This pressure zone also is typically temperature controlled with use of hot oil to a temperature of about (21° C.) 70° F. to about (288° C.) 550° F., typically at about (193° C.) 380° F. Advantageously, pressurized cooling assists in avoiding separation of the resin from the substrate 24, e.g., advantageously assists in avoiding the PET resin inside the CFRT laminate 22 from separating from wood, according to an exemplary embodiment. It has further been determined that the thermoplastic resin material can shrink during cooling potentially causing the CFRT laminate 22 to break apart from the substrate 24, e.g., wood. However, the inventors have determined how to avoid this breakage with use of the apparatuses and processes described herein including the afore-described pressurized cooling and/or further processing described below.

For instance, in order to assist in maintaining the integral bond of the composite structure exiting the pressure bonding section 45, the composite is subjected to additional nip/calendar roll processing, according to embodiments. In particular, according to the embodiment shown in FIG. 5, upon exiting the pressure bonding section 45, the composite structure enters a second set of rolls 47 to further press the composite structure. As in the case of the first set of rolls 43, the second set of rolls 47 can also comprise adjustable height and pressure controls, and is typically about 1 to 3 inches in height operating at about 5 psi with a machine range of about 0 psi to about 200 psi. Similarly, the temperature and flow are adjustable, and exemplary parameters include about 10 to 15 gal/min at about 60 psi at a temperature of about 4° C. (40° F.) to about (121° C.) 250° F. including about (21° C.) 70° F. to about (38° C.) 100° F. As also in the case of the first set of rolls 43, the second set of rolls 47 typically comprises nip or calendaring rolls. The preferred temperature of the rolls 47 is about the same as the melting temperature of the CFRT laminate 22. The rolls 47 are also typically constructed of a conforming material, such as silicone, to account for possible variations in the surface of the substrate 24. During processing, the rolls 47 press molten thermoplastic resin into the substrate 24, such as into the grains of wood, thereby further forming the integrated bond between the materials. It is noted that during the pressing between rolls 47 shown in FIG. 5, the temperature of the composite structure therebetween is typically between about 100° C. (212° F.) to about 350° C. (662° F.) and preferably between about 220° C. (428° F.) to about 300° C. (572° F.), according to embodiments.

According to embodiments and as shown in FIG. 5, the composite structure then enters a first cooling section 51 to help ensure that the bond can completely solidify and the material can be handled. The cooling system of the first cooling section 51 typically includes chilled water flowing through aluminum platens, which can be spring loaded to follow the contour of the bonded composite. It will be appreciated, however, that other cooling mechanisms may be employed such as, e.g., pressurized air, fan cooling, direct contact water cooling, and so forth.

As further shown in FIG. 5 and according to embodiments, upon exiting the first cooling section 51 and to assist in further solidifying the bonding interface, the composite structure then enters a third set of rolls 53. It is noted that the third set of rolls 53 and processing parameters with respect thereto can be described as in the case of the above-referenced first and second set of rolls, 43, 47, respectively. However, during pressing between the third set of rolls 53, the temperature of the composite structure therebetween is typically lower than that of the composite structure pressed between the rolls 47 described above. For example, the temperature of the composite structure with respect to rolls 53 at this cooling stage is typically between about 20° C. (68° F.) to about 200° C. (392° F.) and preferably between about 100° C. (212° F.) to about 200° C. (392° F.).

As further shown in FIG. 5, upon exiting the third set of rolls 53 and according to embodiments, the composite structure then proceeds to a second cooling section 55 configured to remove heat from the composite structure and help ensure the complete solidification of the bond between the substrate 24 and laminate 22. It is noted that the descriptions and processing parameters for the second cooling section 55 can be described as in the case of the first cooling section 51 detailed above.

Lastly, as further shown in FIG. 5, according to embodiments, the composite structure exiting the second cooling section 55 then enters a fourth set of roll 57 to even further solidify the bonding interface. It is noted that the fourth set of rolls 57 and processing parameters with respect thereto can be described as in the case of the above-referenced first, second, and third set of rolls, 43, 47, 53, respectively. However, during pressing between the fourth set of rolls 57, the temperature of the composite structure therebetween may be lower than that of the composite structure pressed between the third set of rolls 53 described above. For example, the temperature of the composite structure with respect to rolls 57 at this subsequent cooling stage is typically between about 20° C. (68° F.) to about 200° C. (392° F.) and preferably between about 20° C. (68° F.) and about 100° C. (212° F.), thereby forming an integrally, mechanically bonded and solidified composite structure. Desirably, prior to handling the resultant composite structure may be allowed to set, such as for about two hours or less at room temperature.

It will be appreciated that while FIG. 5 depicts multiples heating, cooling and pressing stages, more or less stages could be employed during processing. For instance, while apparatus 37 of FIG. 5 has been described as including a first through fourth set of rolls, 43, 47, 53, and 57, respectfully, more or less rolls could be employed, according to embodiments. Similarly, while FIG. 5 depicts a first cooling section 51 and a second cooling section 55, more or less cooling sections could be employed, according to embodiments.

Additionally, while not required, the laminate 22 could also be bonded to the substrate 24 with the use of an adhesive, according to embodiments. For example, the laminate 22 and substrate 24 could enter the apparatuses as described above, with an added adhesive between the substrate 24 and laminate 22. Any suitable adhesive could be employed and is, e.g., typically heat and/or pressure activated.

A non-limiting example of a resultant composite structure 20 capable of being produced herein is further illustrated in FIG. 3. Specifically, FIG. 3 illustrates a five ply composite structure 20 of, e.g., FIG. 2 with the plies bonded to each other and bonded to substrate 24. FIG. 3 further illustrates a non-limiting shape that the resultant composite structure 20 can be formed/machined into, depending upon desired application and end use.

Accordingly, as a non-limiting example and with further reference to apparatus 37 of FIG. 5, e.g., one to five layers of PET/fiberglass composite fiber reinforced thermoplastic (CFRT) laminate 22 are unwound from a tension control spindle of an uwind section 42. The CFRT laminate 22 is guided in such a way to align the edge of the laminate 22 to the incoming substrate 24, e.g., wood. Each bonding surface is subjected to infrared heat applied by IR quartz emitters 67. The CFRT laminate 22 is heated to, e.g., 450° F. depending upon the thermoplastic melt temperature, to induce flow into the CFRT's resin. The surface of the wood substrate 24 is also heated to reduce a freezing effect of the thermoplastic plastic material upon contacting the substrate 24. Simultaneously, the CFRT layers of the CFRT laminate 22 and the wood substrate 24 are pressed together at the first set of rolls 43 (e.g., calendaring nip rolls). The first set of rolls 43 are temperature controlled by means of hot oil within a range of about 70° F. to about 550° F. Preferably, the temperature of the rolls is the same as the melting temperature of the CFRT. The rolls are constructed of a conforming material such as silicon to make up for variations in the surface of the substrate 24. The rolls are used to press molten thermoplastic resin into the grain of the wood substrate 22 initiating the bond interface. As the composite structure comprised of wood and CFRT advances past the first set of rolls 43, it is subjected to pressure in a pressure bonding section 45 including a set of calendaring nip rolls which are smaller and temperature controlled that press the composite structure. The pressure needed to press the PET resin into the wood is a minimum of about 10 psi in this example. The material is then subjected to additional nip rolling to maintain the bond through the system. For instance, after processing via a second set of rolls 47, the CFRT/wood composite is cooled so the bond can completely solidify and the material can be handled. The cooling system includes in this example chilled water flowing through aluminum platens. The platens are spring loaded to follow the contour of the bonded composite. The resulting material is an integrally and mechanically bonded composite of high strength. The material can be tested by means of a pull off test in which the force required to remove the CFRT is measured. The goal of the pull off test is that the wood will separate from itself before the bond between the CFRT and wood separates.

The material can also be tested by cyclic exposure to vacuum and pressure while submerged in water, followed by steam treatment and oven drying. The EXAMPLE below describes such testing on samples, according to embodiments of the invention.

### Example

ASTM D2559-12a (Standard Specification for Adhesives for Structural Laminated Wood Products for Use Under Exterior (Wet Use) Exposure Conditions) Sections 15.3 and 15.4 were used to evaluates samples regarding resistance to delamination during accelerated exposure. The samples, detailed below, were produced according to embodiments of the invention described herein. Table 1 sets forth below some of the tested samples of various types of fiber reinforced material laminated to composite hardwood substrates.

TABLE 1
Sample

PETG 6763 Resin (specimens 1 through 6)
PETG 5011 1 layer (specimens 1 through 6)
PETG 5011 3 layer (specimens 1 through 6)

The testing included cyclical exposure to vacuum and pressure while submerged in water, steam treatment and oven drying. More specifically, during cycle 1 of the testing, the specimens were weighed and then submerged in water in a pressure vessel. A vacuum of 25 in. Hg was applied for 5 minutes. The vacuum was released and a pressure of 75 psig was then applied for 60 minutes. The vacuum/pressure sequence was repeated while the specimens remained submerged in the vessel. The specimens were then placed in an oven at 65° C. for 22 hours overnight. In cycle 2, the specimens were removed from the oven, weighed and placed in a steam chamber for 1.5 hours. The specimens were then returned to the pressure vessel, submerged in water and subjected to 75 psig for 40 minutes, followed by placing the specimens in an oven at 65° C. for 22 hours overnight. Cycle 3 of the testing included a repeat of cycle 1.

After the final oven drying period, the specimens were weighed and examined visually to determine the extent of any bond line delamination. A 10× stereo microscope including a light source was employed, if needed, to determine delamination to the nearest 0.05 inches, as per the D2559 standard. Table 2 below sets forth delamination and weight measurements of the samples.

TABLE 2

| | Total | | |
|---|---|---|---|
| | Bondline | Total | |
| | length | Delamination | % of |
| Sample | (inches) | (inches) | Bondline |
| PETG 6763 Resin (1) | 10.30 | 0 | 0 |
| PETG 6763 Resin (2) | 10.40 | 2.55 | 25 |
| PETG 6763 Resin (3) | 10.30 | 0 | 0 |
| PETG 6763 Resin (4) | 10.50 | 0 | 0 |
| PETG 6763 Resin (5) | 10.30 | 0 | 0 |
| PETG 6763 Resin (6) | 10.40 | 0 | 0 |
| PETG 5011 1 layer (1) | 10.40 | 0 | 0 |
| PETG 5011 1 layer (2) | 10.30 | 0 | 0 |
| PETG 5011 1 layer (3) | 10.30 | 0 | 0 |
| PETG 5011 1 layer (4) | 10.40 | 0 | 0 |
| PETG 5011 1 layer (5) | 10.30 | 0 | 0 |
| PETG 5011 1 layer (6) | 10.20 | 0 | 0 |
| PETG 5011 3 layer (1) | 10.30 | 0 | 0 |
| PETG 5011 3 layer (2) | 10.30 | 0 | 0 |
| PETG 5011 3 layer (3) | 10.30 | 0 | 0 |
| PETG 5011 3 layer (4) | 10.60 | 2.65 | 25 |
| PETG 5011 3 layer (5) | 10.60 | 0 | 0 |
| PETG 5011 3 layer (6) | 10.20 | 0 | 0 |

Table 3 below sets forth a summary of the test results of the above-noted samples. The % delamination for each sample type was determined by summing the individual delamination lengths for all samples of each type and dividing that by the sum of the individual bondlines for each type.

TABLE 3

| | Total | Total | |
|---|---|---|---|
| | Bondline | Delamination | % |
| Sample | (inches) | (Inches) | Delamination |
| PETG 6763 Resin | 62.20 | 2.55 | 4 |
| PETG 5011 1 layer | 61.90 | 0 | 0 |
| PETG 5011 3 layer | 62.30 | 2.65 | 4 |

In summary, the foregoing three groups of samples had a majority of the specimen pass the protocol with the PETG 5011 1 layer samples exhibiting a 100% pass rate.

Advantages of embodiments of the invention include composite structures having, e.g., varied applications, such as in building panels, flooring for buildings, homes, trailers or other structures, as well as further applications such as in roofs, ceilings, doors and armor panels, among other applications.

Further advantages of embodiments of the invention include composite structures that are, e.g., economical, can withstand high loads, resist weather damage and damage from operator interaction, and can have an increased usable lifespan in comparison to thermoset composites or even non-composite structures. Additionally, the composite structures disclosed herein can function as weather barriers and impact layers to objects which may strike/hit the structures, according to embodiments.

Still further advantages of embodiments disclosed herein include that the reinforced plies (layers) can be particularly configured to meet application requirements. For example, the fibers can be orientated 0° to 360° relative to a reference direction, e.g., the substrate 24 or a particular ply, including all angles therebetween, and can comprise multiple plies (layers) to create multiple directional stiffeners and increase torsional rigidity. The fibers 32 could also be altered/chosen to provide desirable properties such as, e.g., increased strength or satisfy cost limitations. Similarly, the fiber content within the one or more plies can be altered to, e.g., reduce weight, increase strength, reduce cost, and so forth.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims. Thus, it is to be understood that the present invention is by no means limited to the particular construction herein disclosed and/or shown in the drawings, but also comprises any modifications or equivalents within the scope of the disclosure. Additionally, it is noted that the embodiments and features disclosed herein can be used in any combination with each other. Moreover, all ranges disclosed herein also include all values between each recited range.

What is claimed is:

1. A composite structure comprising:
a laminate comprising a composite ply, wherein the composite ply comprises a plurality of fibers in a thermoplastic matrix; and
a substrate, wherein the laminate is integrally bonded to the substrate.

2. The composite structure of claim 1, comprising a plurality of composite plies including at least a first composite ply and a second composite ply, each composite ply comprising a plurality of longitudinally oriented fibers in a thermoplastic matrix;
wherein the plurality of composite plies are bonded together to form the laminate and wherein the first composite ply is disposed with the fibers therein oriented in transverse relation to the fibers in the second composite ply.

3. The composite structure of claim 2 wherein the fibers in the first composite ply are different from the fibers in the second composite ply.

4. The composite laminate of claim 3 wherein the fibers in the first composite ply are disposed at about 90° relative to the fibers in the second composite ply.

5. The composite laminate of claim 2 wherein the thermoplastic matrix comprises polyethyleneterephthalate, the fibers comprise fiberglass and the substrate comprises wood.

6. An apparatus for making a composite structure, the composite structure comprising a) a laminate comprising a composite ply, wherein the composite ply comprises a plurality of fibers in a thermoplastic matrix; and b) a substrate, wherein the laminate is integrally bonded to the substrate, the apparatus comprising:
a preheat section configured to receive and heat the laminate and the substrate creating an integral bond between the laminate and the substrate to form a preheated laminate/substrate layup;
an unwind section configured to deliver the laminate to the preheat section; and
a double belted laminating press for receiving the preheated laminate/substrate layup; the double belted laminating press comprising:
a first belt and a second belt configured to pull the preheated laminate/substrate layup into the double belted laminating press;
a heating section configured to receive and further heat the laminate/substrate layup to produce a heated composite structure;
pressure rollers configured to receive the heated composite structure; and
a cooling section configured to receive the heated composite from the pressure rollers and remove heat from the structure.

7. A method of making a composite structure, the composite structure comprising a) a laminate comprising a composite ply, wherein the composite ply comprises a plurality of fibers in a thermoplastic matrix; and b) a substrate, wherein the laminate is integrally bonded to the substrate, the method comprising:
preheating the laminate and the substrate creating an integral bond between the laminate and the substrate to form a preheated laminate/substrate layup;
providing a double belted laminating press for receiving the preheated laminate/substrate layup; wherein a first belt and a second belt of the laminating press pull the preheated laminate/substrate layup into the double belted laminating press for processing;
further heating in a heating section of the laminating press the preheated laminate/substrate layup to produce a heated composite structure;
pressing the heated composite structure with the use of pressure rollers in the laminating press; and
cooling the heated composite structure in a cooling section of the laminating press after the heated composite structure exits the pressure rolls.

8. The method of claim 7 further comprising delivering the laminate to the preheat section with use of an unwind section.

9. An apparatus for making a an integrally bonded composite structure, the composite structure comprising a) a laminate comprising a composite ply, the composite ply comprising a plurality of fibers in a thermoplastic matrix; and b) a substrate, wherein the laminate is integrally bonded to the substrate, the apparatus comprising:
a heating section configured to receive and heat the laminate and the substrate to form a heated laminate/substrate layup;
an unwind section configured to deliver the laminate to the heating section;
a set of rolls configured to receive the heated laminate/substrate layup from the heating section to press the laminate into the substrate forming a bonding interface in the composite structure;
a pressure bonding section configured to receive the composite structure from the set of rolls; and a cooling section configured to cool and solidify the bonding interface.

10. The apparatus of claim 9 wherein the heating section comprises infrared emitters.

11. The apparatus of claim 10 wherein the cooling section comprises water filled aluminum platens.

12. The apparatus of claim 9 wherein the composite structure comprises a plurality of composite plies including at least a first composite ply and a second composite ply, each composite ply comprising a plurality of longitudinally oriented fibers in a thermoplastic matrix;
wherein the plurality of composite plies are bonded together to form a laminate and wherein the first composite ply is disposed with the fibers therein oriented in transverse relation to the fibers in the second composite ply.

13. The apparatus of claim 12 wherein the thermoplastic matrix comprises polyethyleneterephthalate, the fibers comprise fiberglass and the substrate comprises wood.

14. An apparatus for making an integrally bonded composite structure, the composite structure comprising a) a laminate comprising a composite ply, the composite ply comprising a plurality of fibers in a thermoplastic matrix; and b) a substrate, wherein the laminate is integrally bonded to the substrate, the apparatus comprising:
a heating section configured to receive and heat the laminate and the substrate to form a heated laminate/substrate layup;
an unwind section configured to deliver the laminate to the heating section;
a first set of rolls configured to receive the heated laminate/substrate layup from the heating section to press the laminate into the substrate forming a bonding interface in the composite structure;
a pressure bonding section configured to receive the composite structure from the first set of rolls;
a second set of rolls configured to receive the composite structure from the pressure bonding section and further press the composite structure;
a first cooling section configured to receive the composite structure from the second set of rolls to solidify the bonding interface and form a bond therebetween;
a third set of rolls configured to receive the composite structure from the cooling section and further press the composite structure to maintain the bond;
a second cooling section configured to receive the composite structure from the third set of rolls to remove heat from the composite structure; and
a fourth set of rolls configured to receive the composite structure from the second cooling section and further press the composite structure, thereby forming the integrally bonded composite structure.

15. The apparatus of claim 14 wherein the heating section comprises infrared emitters.

16. The apparatus of claim 15 wherein the cooling section comprises water filled aluminum platens.

17. The apparatus of claim 14 wherein the composite structure comprises a plurality of composite plies including at least a first composite ply and a second composite ply, each composite ply comprising a plurality of longitudinally oriented fibers in a thermoplastic matrix;
wherein the plurality of composite plies are bonded together to form a laminate and wherein the first composite ply is disposed with the fibers therein oriented in transverse relation to the fibers in the second composite ply.

18. The apparatus of claim 17 wherein the thermoplastic matrix comprises polyethyleneterephthalate, the fibers comprise fiberglass and the substrate comprises wood.

19. A method of making an integrally bonded composite structure, the composite structure comprising a laminate comprising a composite ply, wherein the composite ply comprises a plurality of fibers in a thermoplastic matrix; and a substrate, wherein the laminate is integrally bonded to the substrate, the method comprising:
a) heating the laminate and the substrate to form a heated laminate/substrate layup;
b) pressing the laminate of the heated laminate/substrate layup into the substrate of the heated laminate/substrate layup using at least one set of calendaring nip rolls to form a bonding interface in the composite structure;
c) applying high pressure of at least about 100 psi to the composite structure of b); and
d) cooling and solidifying the bonding interface of the composite structure of c).

20. The method of claim 19 wherein the thermoplastic matrix comprises polyethyleneterephthalate, the fibers comprise fiberglass and the substrate comprises wood.
